(19) United States
(12) Patent Application Publication
(10) Pub. No.: US 2006/0159158 A1
(43) Pub. Date: Jul. 20, 2006

(54) Contactless connector systems

(75) Inventors: Mark Justin Moore, Cambridge (GB); Jack Arnold Lang, Cambridge (GB); Stephen Ellwood, Cambridge (GB)

Correspondence Address: STERNE, KESSLER, GOLDSTEIN & FOX PLLC, 1100 NEW YORK AVENUE, N.W., WASHINGTON, DC, 20005, US

(73) Assignee: Artimi Ltd, Cambridge (GB)

(21) Appl. No.: 11/312,637

(22) Filed: Dec. 21, 2005

Related U.S. Application Data
(60) Provisional application No. 60/641,430, filed on Jan. 6, 2005.

(30) Foreign Application Priority Data
Dec. 22, 2004 (GB) 0428046.7

(51) Int. Cl. H04B 1/69

(52) U.S. Cl. 375/130

(57) ABSTRACT

A system and method uses near-field or inductively coupled UWB (Ultra Wide Band) systems to implement high speed electrical data connectors without the need for a direct electrical connection. A data connector system has a first connector portion and a second connector portion. The first connector portion comprises a UWB transmitter with a data input and a first UWB coupling element driven by the UWB transmitter. The second connector portion comprises a second UWB coupling element and a UWB receiver with a data output. The UWB receiver has an input from the second UWB coupling element. The data connector system has a connected configuration in which the first and second UWB coupling elements are within an operative range of one another, such that the coupling elements are inductively coupled to one another to permit data to be transferred from the data input to the data output, and a disconnected configuration in which the first and second connector portions are separated by greater than the operative range.

### CROSS REFERENCE TO RELATED APPLICATIONS

This application claims priority under 35 U.S.C. 119(e) to U.S. Provisional Patent Application No. 60/641,430, filed Jan. 6, 2005 and under 35 U.S.C. 119 to GB Application 0428046.7, filed Dec. 22, 2004, which are both incorporated by reference herein in their entireties.

### BACKGROUND

1. Field of the Invention

This invention is generally concerned with the use of near-field or inductively coupled UWB (Ultra Wide Band) systems to implement high speed electrical data connectors without the need for a direct electrical connection.

2. Related Art

Techniques for UWB communication developed from radar and other military applications, and pioneering work was carried out by Dr G. F. Ross, as described in U.S. Pat. No. 3,728,632, which is incorporated by reference herein in its entirety. Ultra-wideband communications systems employ very short pulses of electromagnetic radiation (impulses) with short rise and fall times, resulting in a spectrum with a very wide bandwidth. Some systems employ direct excitation of an antenna with such a pulse which then radiates with its characteristic impulse or step response (depending upon the excitation). Such systems are referred to as carrierless or “carrier free” since the resulting RF emission lacks any well-defined carrier frequency. However, other UWB systems radiate one or a few cycles of a single or multiple high frequency carriers.

Various modulation techniques may be employed, including pulse position, amplitude and/or phase modulation, CDMA (code division multiple access)-based techniques and OFDM (orthogonal frequency division multiplexed)-based techniques (in multicarrier systems). The U.S. Federal Communications Commission (FCC) defines UWB as a −10 dB bandwidth of at least 25% of a center (or average) frequency or a bandwidth of at least 1.5 GHz; the U.S. DARPA definition is similar but refers to a −20 dB bandwidth. Such formal definitions are useful and clearly differentiates UWB systems from conventional narrow and wideband systems, but the techniques described are not limited to systems falling within this precise definition, and may be employed with similar systems employing very short pulses of electromagnetic radiation.

### SUMMARY

UWB communications systems have a number of characteristics that can make then more desirable than conventional systems. Broadly speaking, the very large bandwidth facilitates very high data rate communications and since pulses of radiation are employed the average transmit power (and also power consumption) may be kept low even though the power in each pulse may be relatively large. Also, since the power in each pulse is spread over a large bandwidth, the power per unit frequency may be very low indeed, allowing UWB systems to coexist with other spectrum users and, in military applications, providing a low probability of intercept. The short pulses also make UWB communications systems relatively unsusceptible to multipath effects since multiple reflections can in general be resolved. The use of short pulses also facilitates high resolution position determination and measurement in both radar and communication systems. Finally UWB systems lend themselves to a substantially all-digital implementation, with consequent cost savings.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1a to 1d show, respectively, UWB transceiver, and transmitted UWB signal, a carrier-based UWB transmitter, and a block diagram of a UWB receiver.

FIGS. 2a to 2c show, respectively, a data connector system according to one embodiment of an aspect of the present invention, inductive (transformer) coupling between a pair of UWB coupling elements, and an inductive electrical power transfer system for use with embodiments of the present invention.

FIGS. 3a and 3b show, respectively, a docking station and a mechanical connector, incorporating embodiments of the present invention.

FIGS. 4a to 4d illustrate alternative embodiments of the present invention.

FIGS. 5a and 5b show embodiments of an aspect of the present invention, which provides selectable coupling-based functionality.

FIGS. 6a and 6b show one embodiment of the present invention configured to provide a plurality of multiplexed data connections.

FIGS. 7a to 7c show examples of electronic devices and associated docking stations implementing embodiments of the present invention.

FIG. 8 shows a block diagram of a data connection system for a laptop docking station.

FIG. 9 shows a block diagram of a UWB connector system encoding data bits sent through the connector as patterns of UWB impulses.

FIGS. 10a and 10b show a view from above and a side view of a UWB data connection back plane and associated electronic circuit cards.

FIGS. 11a and 11b show first and second examples of driver architectures for UWB data connectors systems.

The present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

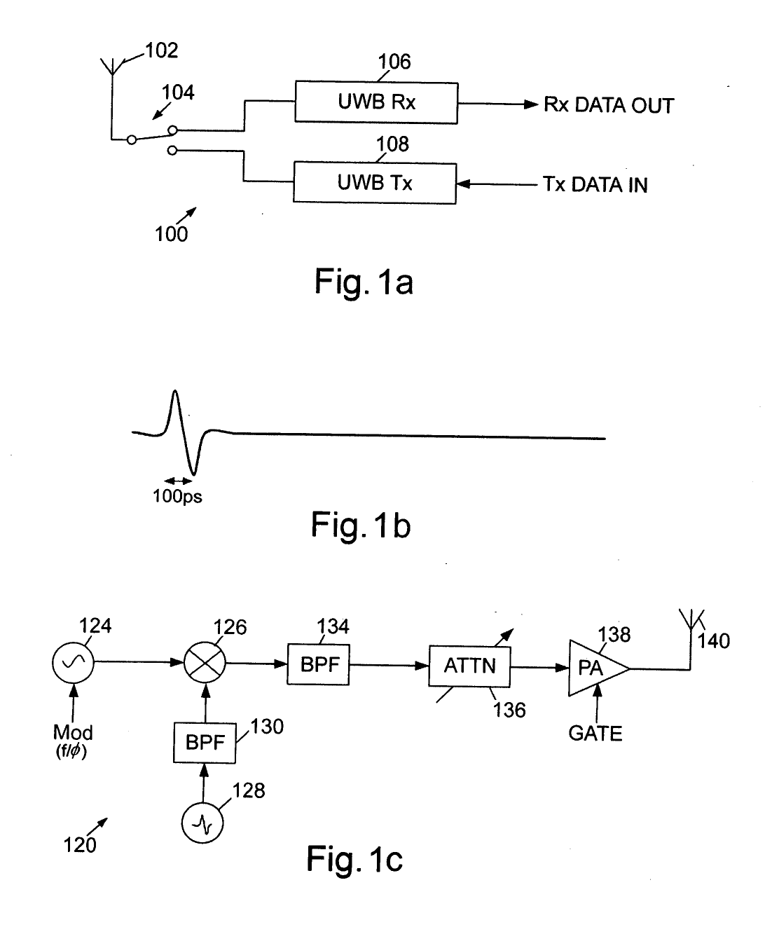

FIG. 1a shows an example of a UWB transceiver 100 comprising a transmit/receive antenna 102 coupled, via a transmit/receive switch 104, to a UWB receiver 106 and UWB transmitter 108. In alternative arrangements, separate transmit and receive antennas may be provided.

The UWB transmitter 108 may comprise an impulse generator modulated by a base band transmit data input and, optionally, an antenna driver (depending upon the desired output power). One of a number of modulation techniques may be employed, for example on-off keying (transmitting or not transmitting a pulse), pulse amplitude modulation, or pulse position modulation. A typical transmitted pulse is shown in FIG. 1b and has a duration of less than Ins and a bandwidth of the order of gigahertz.

FIG. 1c shows an example of a carrier-based UWB transmitter 120. This form of transmitter allows the UWB transmission center frequency and bandwidth to be controlled and, because it is carrier-based, allows the use of frequency and phase, as well as, amplitude and position modulation. Thus, for example, QAM (quadrature amplitude modulation) or M-ary PSK (phase shift keying) may be employed.

Referring to FIG. 1c, an oscillator 124 generates a high frequency carrier which is gated by a mixer 126 which, in effect, acts as a high speed switch. A second input to the mixer is provided by an impulse generator 128, filtered by an (optional) bandpass filter 130. The amplitude of the filtered impulse determines the time for which the mixer diodes are forward biased and hence the effective pulse width and bandwidth of the UWB signal at the output of the mixer. The bandwidth of the UWB signal is similarly also determined by the bandwidth of filter 130. The center frequency and instantaneous phase of the UwB signal is determined by oscillator 124, and may be modulated by a data input 132. An example of a transmitter with a center frequency of 1.5 GHz and a bandwidth of 400 MHz is described in U.S. Pat. No. 6,026,125 (US'125), which is incorporated by reference herein in its entirety. Pulse to pulse coherency can be achieved by phase locking the impulse generator to the oscillator.

The output of mixer 126 is processed by a bandpass filter 134 to reject out-of-band frequencies and undesirable mixer products, optionally attenuated by a digitally controlled RF attenuator 136 to allow additional amplitude modulation, and then passed to a wideband power amplifier 138 such as a MMIC (monolithic microwave integrated circuit), and transmit antenna 140. The power amplifier may be gated on and off in synchrony with the impulses from generator 128, as described in US'125, to reduce power consumption.

FIG. 1d shows a block diagram of a UWB receiver 150. An incoming UWB signal is received by an antenna 102 and provided to an analog front end block 154 which comprises a low noise amplifier (LNA) and filter 156 and an analog-to-digital converter 158. A set of counters or registers 160 is also provided to capture and record statistics relating to the received UWB input signal. The analog front end 154 is primarily responsible for converting the received UWB signal into digital form.

The digitized UWB signal output from front end 154 is provided to a demodulation block 162 comprising a correlator bank 164 and a detector 166. The digitized input signal is correlated with a reference signal from a reference signal memory 168 which discriminates against noise and the output of the correlator is then fed to the detector, which determines the n (where n is a positive integer) most probable locations and phase values for a received pulse.

The output of the demodulation block 162 is provided to a conventional forward error correction (FEC) block 170. In one implementation of the receiver FEC block 170 comprises a trellis or Viterbi state decoder 172 followed by a (de) interleaver 174, a Reed Solomon decoder 176 and (de) scrambler 178. In other implementations other codings/decoding schemes such as turbo coding may be employed.

The output of FEC block is then passed to a data synchronization unit 180 comprising a cyclic redundancy check (CRC) block 182 and de-framer 184. The data synchronization unit 180 locks onto and tracks framing within the received data separating MAC (Media Access Control) control information from the application data stream(s) providing a data output to a subsequent MAC block (not shown).

A control processor 186 comprising a CPU (Central Processing Unit) with program code and data storage memory is used to control the receiver. The primary task of the control processor 186 is to maintain the reference signal that is fed to the correlator to track changes in the received signal due to environmental changes (e.g., the initial determination of the reference waveform, control over gain in the LNA block 156, and on-going adjustments in the reference waveform to compensate for external changes in the environment).

Physical contact connectors are always a weak point in a system for reliability, robustness, and in some cases bandwidth of throughput. This is particularly so in difficult, dirty or hazardous environments, or where the connector is frequently used, such as in a PC docking station or a cell phone or PDA (Personal Digital Assistant) cradle. It would therefore be desirable to be able to replace bus and other connections with a “contactless connector,” which is a connector not reliant upon a direct electrical contact between the connecting portions. Exemplary non-UWB systems can be found in Integrated Antenna as Contactless Connector for Wireless System, Tatsuo Itoh, Department of Electrical Engineering, University of California, Los Angeles, Calif. 90095, Final Report 1997-1998 for MICRO Project 97-069 and www.pcguide.coni/ref/mbsysibuses/funcBandwidth-c.html, which are both incorporated by reference herein in their entireties, but the use of UWB provides some specific desirable featured, as described below.

According to a first embodiment of the present invention, there is provided a data connector system, the system having a first connector portion and a second connector portion. The first connector portion comprises a UWB transmitter with a data input and a first UWB coupling element driven by the UWB transmitter. The second connector portion comprises a second UWB coupling element and a UWB receiver with a data output. The UWB receiver has an input from the second UWB coupling element. The data connector system has a connected configuration in which the first and second UWB coupling elements are within an operative range of one another, such that the coupling elements are inductively coupled to one another to permit data to be transferred from the data input to the data output, and a disconnected configuration in which the first and second connector portions are separated by greater than the operative range.

Providing an ultra wideband inductive coupling, in effect an ultra wideband transformer allows for reliable, although very short range, UWB communication at data transfer rates that can achieve multiple gigabits per second. In one or more embodiments of the system, the operative range is equal to or less than a near-field range of these coupling elements. Such a near-field range may conveniently be defined as equal to a wavelength at a center or average frequency of the UWB band in which the connector system operates (in the case of a multiband system the center frequency of a center band may be employed). Alternatively, and in some instances desirably, the operative range may be defined as less than a wavelength at a maximum frequency of the UWB band employed by the system at, say, a −3 dB or a −10 dB point. Typically, the operative range is less than 3 cm, less than 1 cm, or less than 0.5 cm. The inductive UWB coupling elements may comprise either monopole or bipole elements; the “gap” between these elements typically comprises a non-conductive material, for example part of a plastic casing.

Employing very short range UWB communications has a number of desirable characteristics. First, only a very low power need be employed thus reducing possible concerns over interference to other equipment. Second, the use of very short range communications substantially inhibits and can effectively eliminate multipath interference, simplifying signal reception and processing and facilitating use of impulse UWB signals, which in turn enables a substantially all-digital construction (of transmitter and/or receiver) which can be implemented at low cost. However, it should be noted that references to an operative range do not necessarily imply that beyond this range the connector system is inoperative, although this may be the case. In one example, however, the data connector system becomes inoperative at a relatively short range, for example greater than 1 cm, 5 cm, 10 cm, 50 cm, 100 cm or more. This facilitates reduction of multipath and also “disconnection” of the connectors.

As will be described further later, one or both of the first and second connector portions may either comprise part or all of the conventional style connector configured for mechanical rather than electrical interfacing, or they may be built into equipment, for example an electronic device and an associated docking station.

In embodiments when the first and second connector portions are connected, the first and second coupling elements may be substantially aligned with one another, for example parallel or anti-parallel, or more particularly they may have aligned polarizations. However, in other embodiments the UWB coupling elements have a relatively low degree of polarization so that such alignment is not critical or necessary at all.

One or both of the first and second connector portions may be provided with a plurality of UWB coupling elements which may have substantially the same or different mutual alignments or orientations. With such an arrangement different UWB coupling elements may provide different data connectivity and, in particular, may invoke different data processing functions. For example, connection to one UWB coupling element of a connector portion may invoke a first data processing function whereas connection to another coupling element of the same connector portion may invoke a second data processing function. Such data processing functions may include one or more of a data storage function, a data retrieval function, and a print function (for example for a digital imaging device). In this way a wide range of functions may be provided and selected by a user by simply “connecting” to an appropriate UWB coupling element. In such a system, each UWB coupling element may have a dedicated associated UWB transmitter or receiver (or transceiver) and data processing, or data streams of a plurality of UWB coupling elements may be combined and a data processing function identification system may be generated responsive to connection to a the coupling element.

The very high data rates facilitated by short range UWB transmission enable a plurality of serial and/or parallel data streams to be multiplexed and sent across a single UWB connection. Thus, in one example, one of the first and second connector portions includes a data multiplexer and the other a data de-multiplexer; such an arrangement may be employed to multiplex for example, a data bus and a video data connection across the UWB link.

In one or more embodiments, the data connection system is bi-directional, each connector portion including both a UWB transmitter and a UWB receiver; shared or different coupling elements may be employed for the transmitter and receiver.

In one example, the connector system includes an inductive electrical power transfer system and thus, for example, each of the first and second connector portions may include one or more electrical coils which couple inductively when the connector portions are brought within the operative range (or in other embodiments mated with one another). Where a connector portion includes more than one coil the coils need not all be the same shape, size or area, and maybe configured to allow a degree of translational and/or rotational freedom of the inductive coupling units relative to one another whilst still providing contactless electrical energy transfer; the same is true of the UWB link elements. Such an arrangement facilitates a connection system which entirely lacks a direct mutual electrical connection between the first and second connector portions.

Desirably, such a connector system may be implemented for an electronic device and a docking station for the device; in this case one portion of the connector system is installed within the electronic device and the other portion of the connector system in the docking station. With such an arrangement there is no need for a mechanical interface between the first and second connector portions. For example, the electronic device may simply be laid on top of the docking station. The electronic device may comprise, for example, a consumer electronic device such as a mobile phone, laptop computer, digital camera, PDA, a portable music or video device, and the like. It will be appreciated that, in embodiments, a single docking station may have provision for simultaneous connection with a plurality of electronic devices, for example by providing the docking station with a plurality of first (or second) connector portions.

A contactless connector system as described above is also useful in a hostile or hazardous environment, such as an underwater environment for an environment for which there is a spark risk such as a chemical processing plant. Thus, a substantially environmentally sealed electronic device may be provided by incorporating within the device a data connector system connector portion as described above.

In a further embodiment, an electrical backplane is provided having a plurality of card sockets each incorporating one (or both) of the first and second connector portions. The invention further provides a card having one or more complementary connector portions, for mechanical attachment/mounting on the backplane to provide an inductive UWB coupling between the card and backplane.

According to a related aspect of the invention, there is provided a UWB data connector system, the connector system having a first and second connector parts. The connector parts are configured to mechanically interface to one another. Each of the connector parts includes a UWB coupling element. When the first and second connector parts are interfaced one of the UWB coupling elements is in the near field of the other UWB coupling elements.

In a further related aspect the invention, there is provided a method of providing an electrical data connection using UWB coupling elements. The method comprises the following steps. Receiving data for transmission across the connection. Encoding the data as a UWB signal. Transmitting the UWB signal from a first of the coupling elements. Receiving the UWB signal at a second of the UWB coupling elements. Recovering the data from the received UWB signal. Inductively coupling the first and second UWB coupling elements.

In one example, the encoding encodes the data as an impulsive UWB signal, using one or more patterns or “chirps” of UWB impulses these may be modulated in timing, amplitude and/or phase to encode the data and/or a form of code domain multiple access may be employed using a plurality of different patterns to implement a plurality of different data channels across a single the data connection. One or more data bits, optionally forward error corrected or otherwise coded, may be associated with each pattern of UWB impulses.

One or more embodiments of the present invention also provide an electrical data connector comprising UWB coupling elements. The connector comprises means for receiving data for transmission across the connection, means for encoding the data as a UWB signal, means for transmitting the UWB signal from a first of the coupling elements, means for receiving the UWB signal at a second of the UWB coupling elements, and means for recovering the data from the received UWB signal. The connector is further configured for inductive coupling of the first and second UWB coupling elements.

In a further embodiment of the present invention, there is provided a docking station for an electronic device. The electronic device has a plurality of separate data connections coupled to a near-field UWB interface. The docking station has a near-field USB interface coupled to one or both of a multiplexer and de-multiplexer. The docking station is enabled to connect via an inductive wireless UWB connection to the separate data connections of the electronic device.

In one example, the docking station also includes an inductive electrical power supply system for the electronic device. The separate data connections can include a video data connection, and may also include one or more serial and/or parallel data connections such as a USB (Universal Serial Bus) connection, a PCI bus connection, a FireWire connection, an Ethernet connection, and the like. Such a docking station may be used with a laptop computer without the need for any direct electrical connections between the two.

One or more embodiments of the present invention also provides an environmentally sealed electronic device having one or more external data connections all coupled to a near-field UWB interface. The device is operable using the one or more external data connections without making direct electrical connection to the device.

In one example, the sealed electronic device also includes a receiver to receive electrical power for powering the device inductively from an external power supply unit, for example for charging rechargeable batteries.

A still further embodiment of the present invention provides a method of operating an electronic device in a hostile environment including the following steps. Providing data communications for the device using a near-field UWB coupling. Providing an electrical power supply for the device using an inductive coupling. Operating the device using the electrical power supply to communicate data over the near-field UWB coupling.

One or more embodiments of the present invention can further provide a method of providing short-range UWB data communications comprising the following steps. Inputting data to be communicated. Encoding the data as pattern of UWB impulses. Transmitting the pattern of impulses from a UWB transmitter to a UWB receiver. Receiving the pattern of impulses at the receiver. Decoding the pattern of impulses to provide decoded data; and outputting the decoded data.

In one example, the UWB impulses are transmitted at a power level that is sufficiently low to substantially suppress multipath components of the transmitted signal from being received.

One or more embodiments of the present invention also provide a short-range UWB data communications transmitter comprising means for inputting data to be communicated, means for encoding the data as a pattern of UWB impulses, and means for transmitting the pattern of impulses from a UWB transmitter to a UWB receiver.

One or more embodiments of the present invention also provide a UWB data communications receiver, comprising a received signal input to receive a pattern of UWB impulses, means for decoding the pattern of impulses to provide decoded data, and means for outputting the decoded data.

One or more embodiments of the present invention also provide a method of selecting an operational function to be implemented by an interface unit for an electronic device, the electronic device having a short-range UWB communications interface, the interface unit having a plurality of complementary short-range UWB communications interfaces spaced apart over a region of the unit, each the interface being associated with one of the operational functions, the method comprising selecting a the operational function by bringing the UWB communications interface of the electronic device into range of a selected one of the UWB communications interfaces of the interface unit.

In one example, the UWB communications interface has a range which is short enough to enable selective communications with a selected interface of the interface unit, although the selecting may additionally or alternatively comprise selecting a relative orientation of the electronic device and interface unit interfaces.

One or more embodiments of the present invention also provide an interface unit for implementing a selected one of a plurality of operational functions for an electronic device having a short-range UWB communications interface, the interface unit having a plurality of complementary short-range UWB communications interfaces spaced apart over a region of the unit, each the interface being associated with one of the operational functions, the interface unit comprising means for selecting a the operational function for implementing in response to the electronic device being brought into communications range of a corresponding the communications interface.

In a still further embodiment of the invention present invention, there is provided an electrical backplane system comprising: a backplane, a plurality of mechanical connectors mounted on the backplane, each configured to receive an electronic circuit, a plurality of UWB coupling devices, at least one associated with each the mechanical connector, and one or more wired communications links between two or more of the UWB coupling devices.

In one example, the UWB coupling devices comprise inductive or near field coupling devices. The links between two or more of these coupling devices may either be passive or active. Where active links are employed preferably bi-directional communication between the coupling devices is provided. The back plane may comprise, for example, a back plane or a server rack (in which case the electronic circuits may comprise blade servers), or a communications rack, or part of a personal computer chassis, in which case the back plane may comprise part of a motherboard.

A yet further embodiment of the present invention provides a UWB data connector system, the system comprising a first UWB transceiver, a second UWB transceiver, a first set of software drivers for the first UWB transceiver, and a second set of software drivers for the second UWB transceiver. The first set of drivers comprises a first UWB multiplex driver for providing a plurality of first interfaces to the first UWB transceiver, and a plurality of second drivers coupled to the plurality of first interfaces to provide a plurality of software interfaces. The second set of drivers comprises a second UWB multiplex driver for providing a plurality of second interfaces to the second UWB transceiver. A plurality of third drivers coupled to the plurality of second interfaces to provide a plurality of hardware interfaces.

In one example, the software interfaces comprise application program interfaces, and the hardware interfaces, which may be either internal or external, comprise any one of a plurality of different standard interfaces employed with computers and consumer electronic devices. Such interfaces include (but are not limited to) RS-232, RS-423, RS-485, IEEE-488, IEEE-1394, USB, USB 2, personal computer parallel port, video, composite video, S-video, RGB video, PCI bus, PCI-express bus, PCMCIA interface, Ethernet, and a digital camera interface (any of the various types implemented). More generally any standard hardware interface, for example a standard interface defined by the IEEE, the EIA, the IEC, the ISO or any other standards organization may be implemented. In one example, the software interfaces are configured to provide standard interfaces the hardware interfaces so that, in embodiments, the UWB data connector system is substantially transparent to application software using the system.

One or more embodiments communicate data between the software and hardware interfaces using a plurality of protocols concurrently. In one example, the UWB data connector system employs protocol tunneling to (synchronously) carry a plurality of different protocols across the UWB link between the two transceivers. Optionally, protocol translation may also be provided so that, for example, an IEEE-1394 (Firewire-198 ) driver interface may be used to write to Ethernet or a PCI-express bus. Embodiments of the system may also be used to implement a direct bus-to-bus bridge or a bus-to-multibus bridge, in particular because of the high bandwidth and low latency of UWB communications.

In one example, one or both of the first and second sets of software drivers include a service discovery protocol for discovering when another connector (comprising a transceiver and multiplex driver) is within range and for discovering services provided or requested by this other connector. For example, the second set of software drivers (which provide the hardware interfaces) may advertise the interfaces available to the first set of software drivers, which may then make available appropriate software interfaces to the application programs. Thus, a service discovery protocol may include one or more of a protocol to detect a nearby UWB data connector, a protocol to advertise one or more services which may be offered and a protocol to make available one or more drivers responsive to a service advertisement.

A still further embodiment of the present invention provides a UWB data connector system, the system comprising a first UWB transceiver, a second UWB transceiver, at least one driver for the first UWB transceiver, and at least one driver the second UWB transceiver. One or both of the drivers include a service discovery protocol for discovering one or more services provided or requested by the other the UWB transceiver and driver.

The UWB data connector system may further comprise a third UWB transceiver and a corresponding set of software drivers, to implement point-to-multipoint data connection.

The skilled person will understand that the above-described aspects and embodiments of the invention may be combined in any permutation.

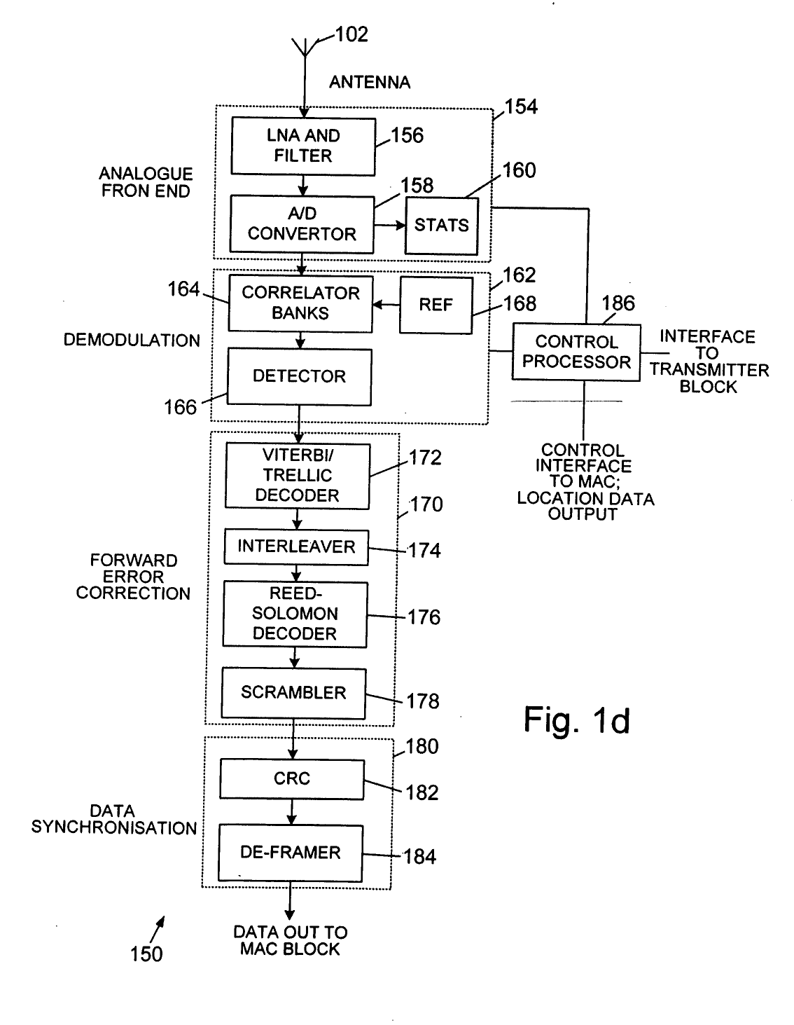

Referring first to FIG. 2a, this shows a data connection system 200 comprising a first connector portion 202 coupled to a second connector portion 204 by means of an inductive or “transformer coupling 206 implemented using a pair of UWB coupling elements 208a, b. Each of these UWB coupling elements may comprise, for example, a conventional UWB antenna, the pair of antennas being positioned relative to one another such that each is in the near field of the other, or closer. Connector portion 202 comprises a UWB transmitter 210 having a data input 212 and providing a UWB signal output to coupling element 208a. Connector portion 204 comprises a UWB receiver 214 which receives a UWB signal from coupling element 208b and provides a corresponding data output 216. The system comprises transmitter 210, coupling element 208a, coupling element 208b and receiver 214 is not designed to radiate externally to the connector system. Broadly speaking, the connector system is designed to implement the “last inch” of a data connection and can thus operate at very low power, among other things reducing the risk of interference.

FIG. 2b illustrates the UWB coupling elements 208a, b in more detail. In the illustrated embodiment these comprise what the inventors have termed “bishops hat” antennas as described in detail in the applicant's co-pending PCT patent application GB2003/005070 filed 21 Nov. 2003, the contents of which are hereby incorporated by reference in their entirety. As illustrated in FIG. 2b, the mutual separation and/or orientation of the pair of UWB coupling elements may be varied.

FIG. 2c shows a contactless inductive electrical power transfer system 250 which may be incorporated within connectors 202, 204 of the data connector system 200 shown in FIG. 2a.

The power transfer system comprises a power transmitting system 252 and a power receiving system 254, the power transmitting system receiving power from a source such as a mains (or grid) supply and the power receiving system 254 providing a DC power output for powering an electronic device, in particular a portable electronic device. The transmitter 252 comprises a power supply 256 providing DC power to one or more drivers 258 which, in turn, provide a low frequency drive signal to one or more power transmission coils 260. The receiver 254 comprises one or more power receiving coils 262 which, when the connector system is in use, are located in close proximity to the transmitting coils 260 to thereby receiver power inductively from the transmitter unit 252. The power received by coils 262 is provided to a power conversion unit 264, which typically rectifies and smoothes the received signal providing a low voltage DC power output 266.

Suitable inductive power transmission systems are described in more detail in GB 2,399,230, GB 2,399,225, GB 2,399,226, GB 2,399,227, GB 2,399,228, GB 2,399,229 and GB 2,398,176, which are all incorporated by reference herein in their entireties, as well as in a number of other similar publications.

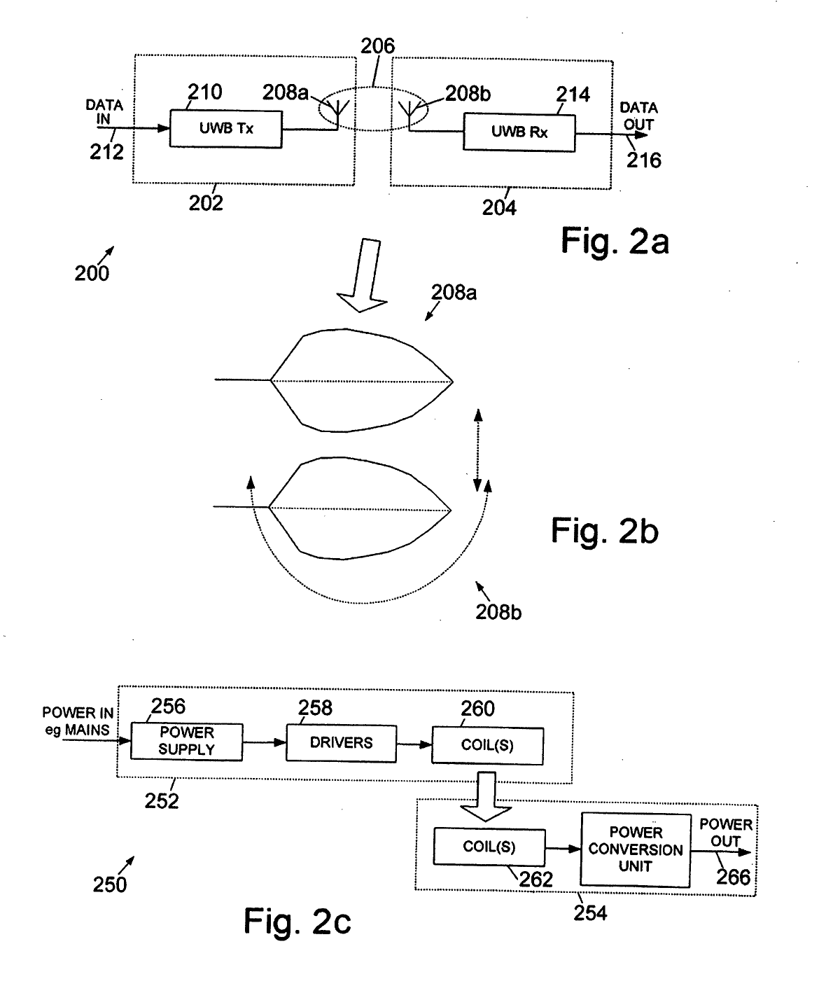

Referring next to FIG. 3a, this shows, schematically, a portable electronic device 300 connected via a data connector system as described above to a docking station 302. In the example of FIG. 3a, the electronic device 300 has a substantially planar surface 304 which abuts a corresponding substantially planar surface 306 of the docking station in such a way that the UWB coupling elements 208a, b are in close proximity to one another and, in the illustrated example, approximately aligned (in FIG. 3a like elements to those of FIG. 2a-c are indicated by like reference numerals). In the example of FIG. 3a, the data connector system also includes a power transfer system comprising coils 260, 262. UWB coupling element 208a and coil 262 are arranged on or adjacent to surface 304 of device 300 (surface 304 being formed from a non-conducting material such as plastic) and likewise coupling element 208b and coil 260 are arranged on or adjacent to an inner surface of face 306 of docking station 302. Although in the example of FIG. 3a only a single pair of coils and a single pair of UWB coupling elements is shown, in practice either or both of device 300 and docking station 302 may incorporate more than one UWB coupling element and/or power transmission/reception coil at different positions and/or orientations.

FIG. 3b shows an alternative embodiment of a data connector system 350 in which coupling elements 208a, b and, optionally coil 260, 262 are incorporated within mechanically mating connector portions 352, 354. Connector portions 352, 354 are configured to releasably mechanically engage with one another, for example by means of clips 356 so that when the connectors are engaged UWB coupling elements 208a, b inductively couple in the near-field to one another to provide a high speed data connection or optionally coils 260, 262 providing electrical power.

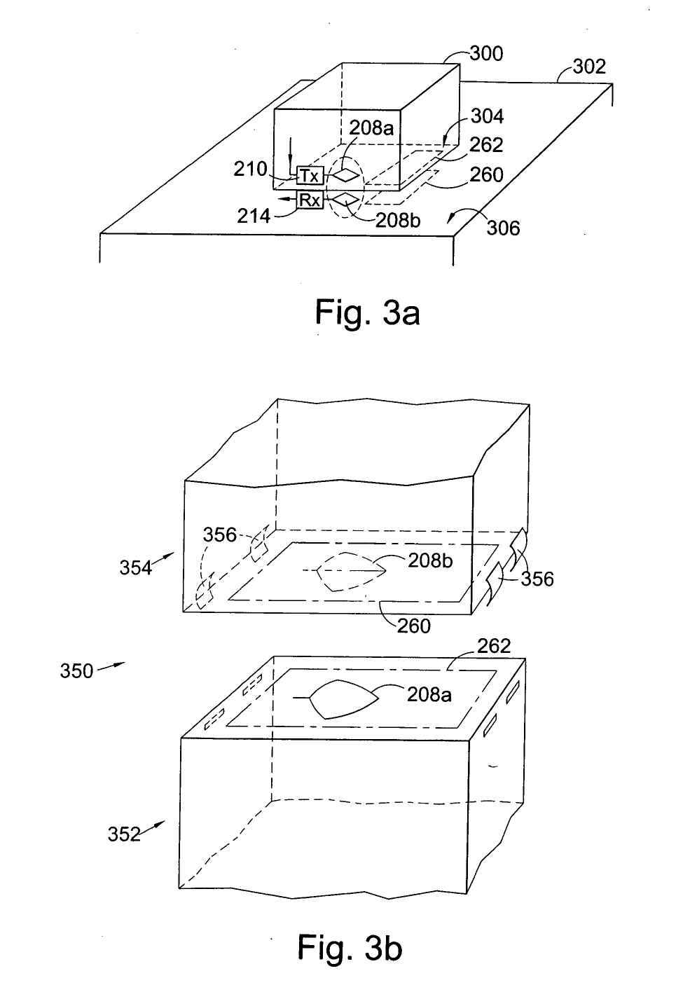

Referring to FIG. 4a, this shows an alternative embodiment of a data connector system 400 similar to system 200 of FIG. 2a, in which like elements are indicated by like reference numerals. In the data connector 400 of FIG. 4a each of the first and second connector portions 402, 404 incorporate a respective UWB transceiver 406, 408 to provide a bi-directional inductive UWB data communications connection. Optionally, provision may also be made for bi-directional inductive electrical power transfer.

FIGS. 4b and 4c illustrate that UWB transmitter 210 of FIG. 2a and/or UWB receiver 214 of FIG. 2a maybe coupled to two or more UWB coupling elements 208aa, 208ab, 208ba, 208bb. As schematically illustrated in FIG. 4d, these UWB coupling elements may be provided at different locations and/or in different orientations with respect to one another to facilitate UWB data coupling, for example in the docking station configuration of FIG. 3a or a similar data connector system in which precise alignment of the connecting portions of the system is not readily achievable.

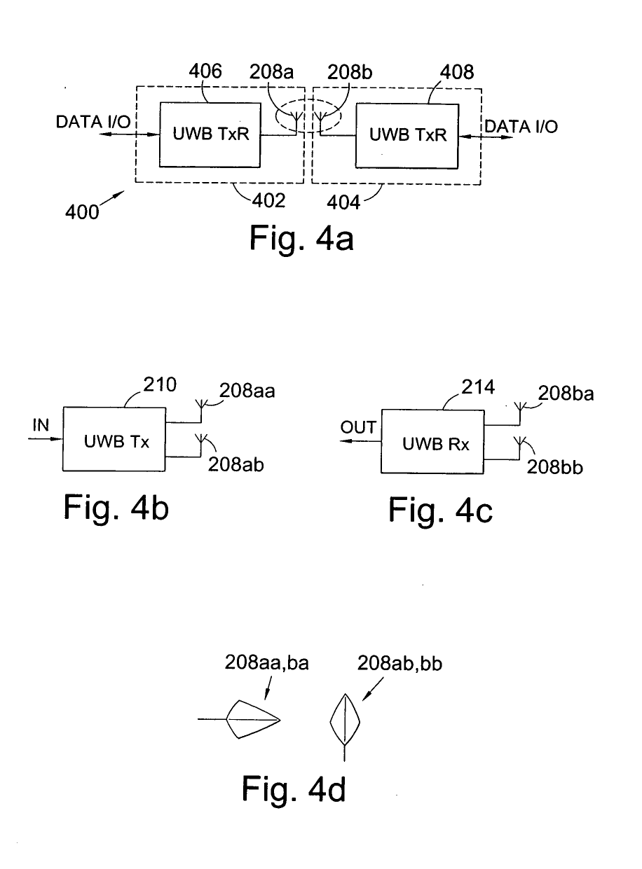

FIG. 5a shows a connector system 500 incorporating means for selecting an operational function in response to selection of a UWB connection. In FIG. 5a, an electronic device 502 comprises a UWB transceiver 504 having a data input/output connected to a UWB coupling element 506. An interface unit 508 such as a docking station comprises a plurality of complementary UWB interfaces 510, 512 spaced apart on the interface unit 508 so that one or another of the interfaces may be selected by selective placement of the electronic device 502 on the interface unit. In the illustrated example, UWB interface 510 comprises a UWB coupling element and UWB receiver whilst interface 512 comprises a UWB coupling element and a UWB transceiver. Interface 510 provides a data output to a printer interface 514 for driving a printer 516 whilst interface 512 provides a data input/output to a data storage interface 518 for writing data into and/or reading data from a data storage device 520. In this way, when UWB coupling element 506 is placed adjacent to interface 510 a print function is invoked whereas when UWB coupling element 506 is placed adjacent to interface 512 a data storage/retrieval function is invoked.

FIG. 5b shows another method of providing similar functionality in which both of interfaces 510, 512 are coupled to a common controller 522 which provides a data input/output connection 524 and a function identification signal 526 identifying a required function in response to the interface 510, 512 to which a connection is made.

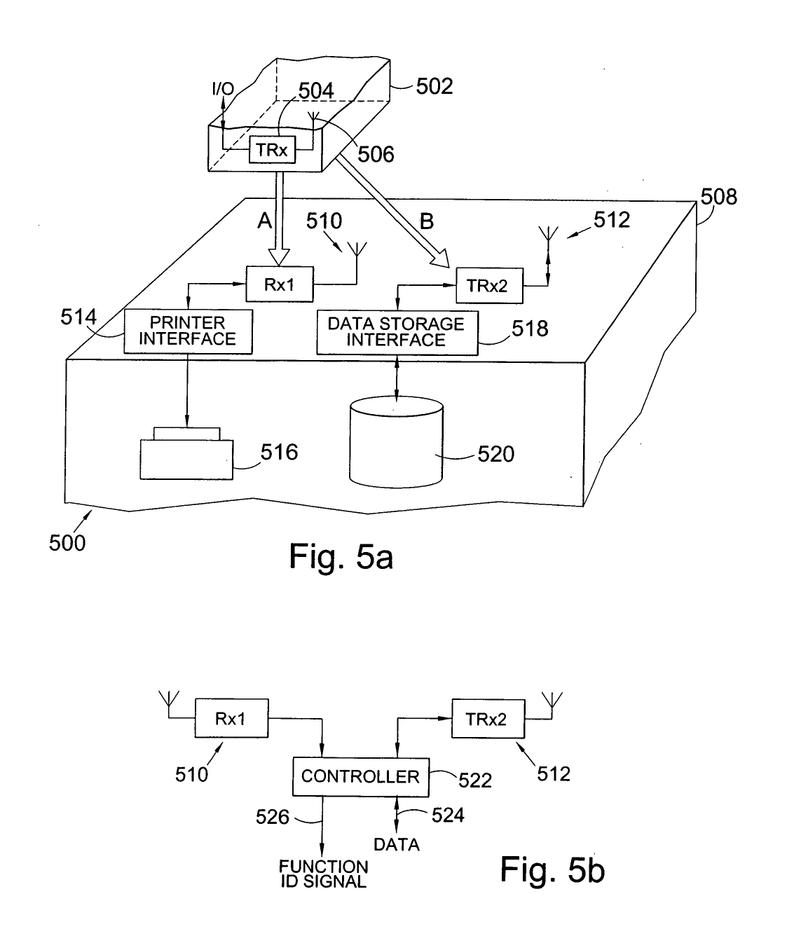

FIG. 6a illustrates how a plurality of data streams may be multiplexed across a single UWB connection. Thus a plurality of data streams 600 is provided to a multiplexer 602 and thence to a UWB data connector system 604, 606 as described above, the output of connector 606 being provided to a de-multiplexer 608 which provides a plurality of de-multiplexed output data streams 610 corresponding to input data stream 600. As illustrated in FIG. 6b, a data stream may be generated from a parallel data bus by means of a serializer 612 and recovered by means of a de-serializer 614. The data communications in FIGS. 6a and 6b may be uni-directional (as shown) or bi-directional. The UWB data connection system can provide data transfer speeds of multiple gigabits per second over very short distances which compares with typical bus speeds of for example, approximately 16 megabytes per second for a 16 Bit ISA bus (bus speed 8.3 MHz), and 127 megabytes per second for a 32 Bit PCI bus (bus speed 33 MHz). It can therefore be seen that connections for a plurality of serial and/or parallel data buses may readily be provided by a single UWB connector.

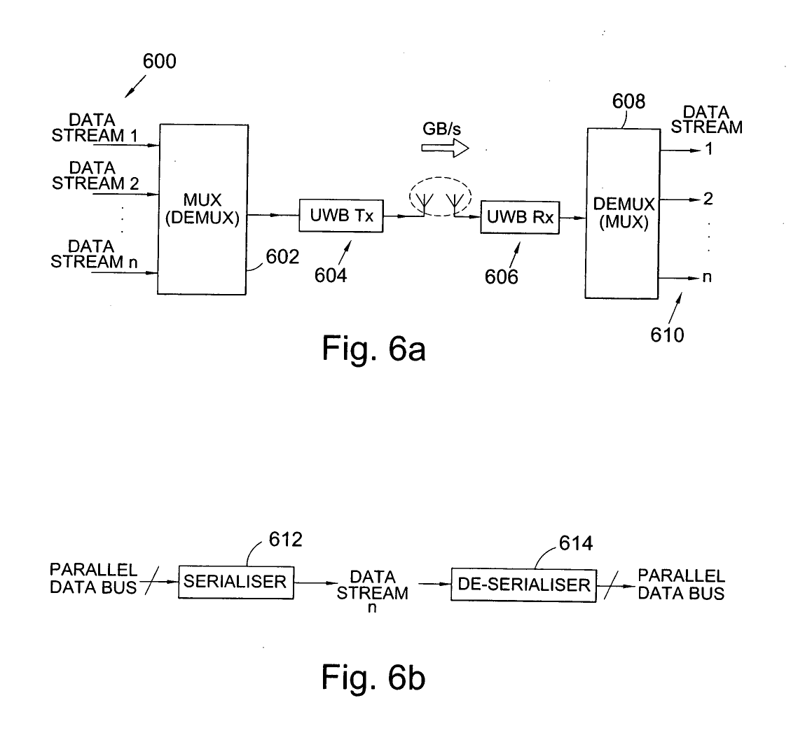

This concept is illustrated in FIG. 7a, which shows a laptop computer 700 and its docking station 702. The laptop computer 700 incorporates a UWB coupler 704 and an inductive electrical power receiver 706 whilst the docking station includes a complementary UWB coupler 708 and inductive electrical power transmitter 710. The docking station 702 provides a video output 712 for a monitor 714, as well as, one or more conventional parallel data bus connections 716 and one or more conventional serial data connections 718. The docking station has a mains power input 720. Data for all these connections and raw data for video connection 712 is carried across the UWB connector system 704, 708 and the laptop is preferably also powered without the use of a direct electrical connection and in this way all of the laptop power and communications may be implemented wirelessly, that is without any direct electrical connectors, thus increasing reliability and ease of use.

FIG. 7b shows a similar concept illustrating a docking station 730 for a mobile communications device 732.

FIG. 7c illustrates a further example, in which a docking station 740 is provided for a digital camera 742. It will be appreciated that because no direct electrical connections are required the digital camera (or other electronic device) may be completely environmentally sealed, for example to provide a waterproof camera. The extremely high speed of the UWB data connection enables the transfer of both still and moving image data within practical time frames.

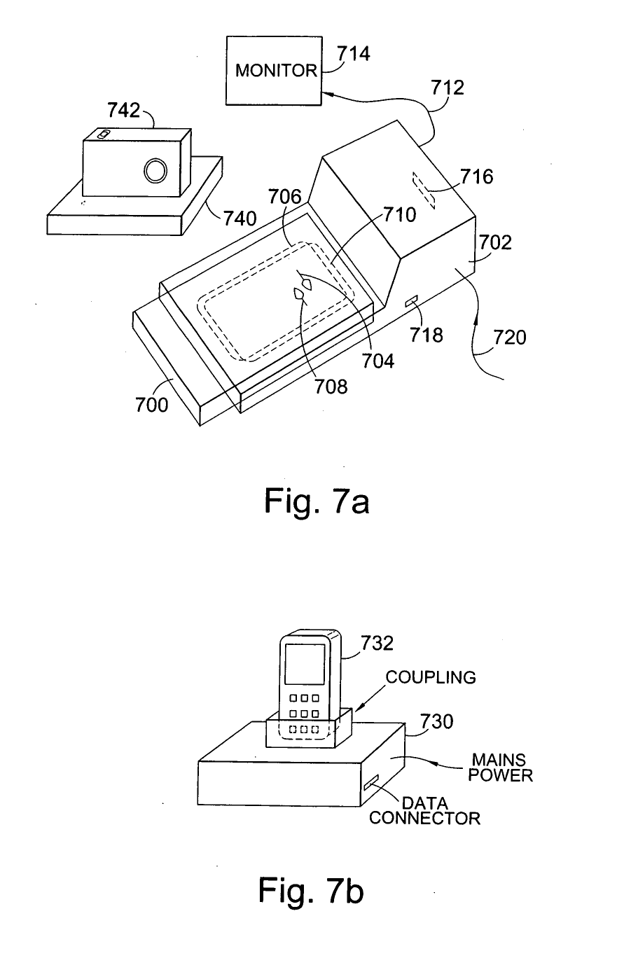

FIG. 8 shows a block diagram of a UWB connector system 800 suitable for implementing in the laptop and docking station of FIG. 7a.

The docking station connector 802 comprises a multiplexer/de-multiplexer and a UWB transceiver 806 connected to a UWB coupler 808. The multiplexer/de-multiplexer has a plurality of input/output connections, for example for one or more of video, a PCI bus, Ethernet, FireWire, USB, PS-2 and other serial or parallel connections. In the laptop, a corresponding multiplexer/de-multiplexer and UWB transceiver 810 is coupled to a UWB coupling element 812, multiplexer/de-multiplexer 810 providing a corresponding set of data connections to multiplexer/de-multiplexer 806. In use, the UWB couplers 808, 812 are positioned close or substantially adjacent to one another to provide inductive or transformer coupling in the near-field achieving multi-gigabit per second data rates with little or no interference to nearby electronic equipment and few or no multipath problems. The connector 802 also incorporates an electrical power input 814 to a driver 816 driving one or more power transmit coils 818, and connector 804 includes one or more corresponding power received coils 820 coupled to a power conversion unit 822 providing a regulated and smoothed DC power output 824 for powering the laptop. Again when connector portions 802, 804 are connected, that is when the laptop is placed on top of the docking station interface, coils 818, 820 are juxtaposed in an electrical power transfer relationship.

In one or more embodiments of the data connector system, in a connected configuration the inductive coupling elements are very close to one another, typical ranges being of the order of 1 cm. This facilitates use of a baseband impulse-based UWB solution which is inexpensive as the circuitry can be substantially all digital. In such a system, one or a set of data bits for transfer across the connector can be encoded as a chirp, which is a relatively short known sequence of pulses with a specific mutual time relationship; optionally such a chirp maybe phase, amplitude or position modulated.

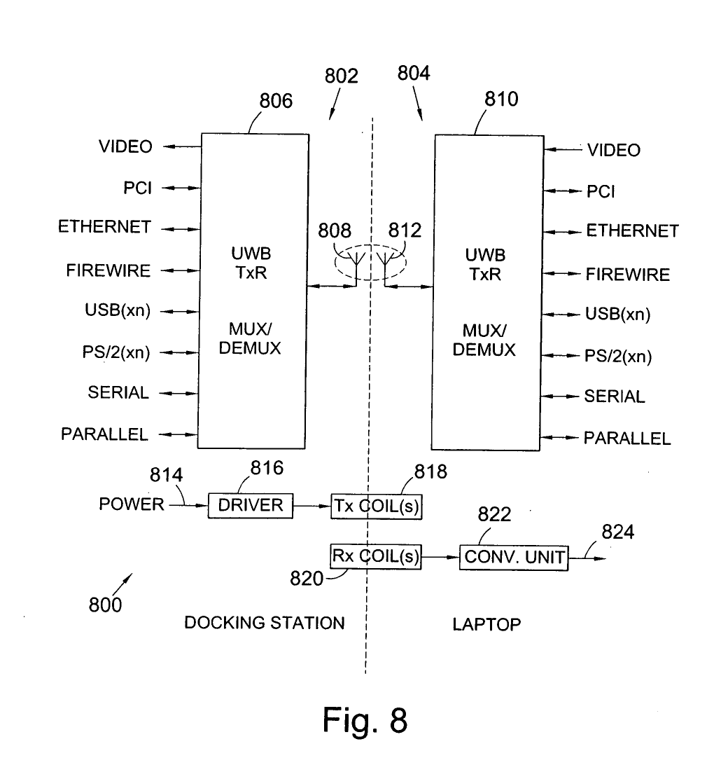

FIG. 9 shows a connector system 900 comprising first 902 and second 904 connector portions configured to encode and decode data in this way. Thus connector portion 902 comprises an encoder 906 followed by a UWB driver 908 and coupling element 910, and connector portion 904 comprises a coupling element 912 feeding a UWB receiver 914 which provides an output to a decoder 916 providing a decoded data output. Data is encoded in a chirp or pattern of pulses such as chirp 918, although optionally a plurality of different types of chirps may be included to implement a plurality of simultaneous data channels, each chirp having a different and preferably substantially orthogonal pattern of pulses such as chirps 918, 920 shown in FIG. 9.

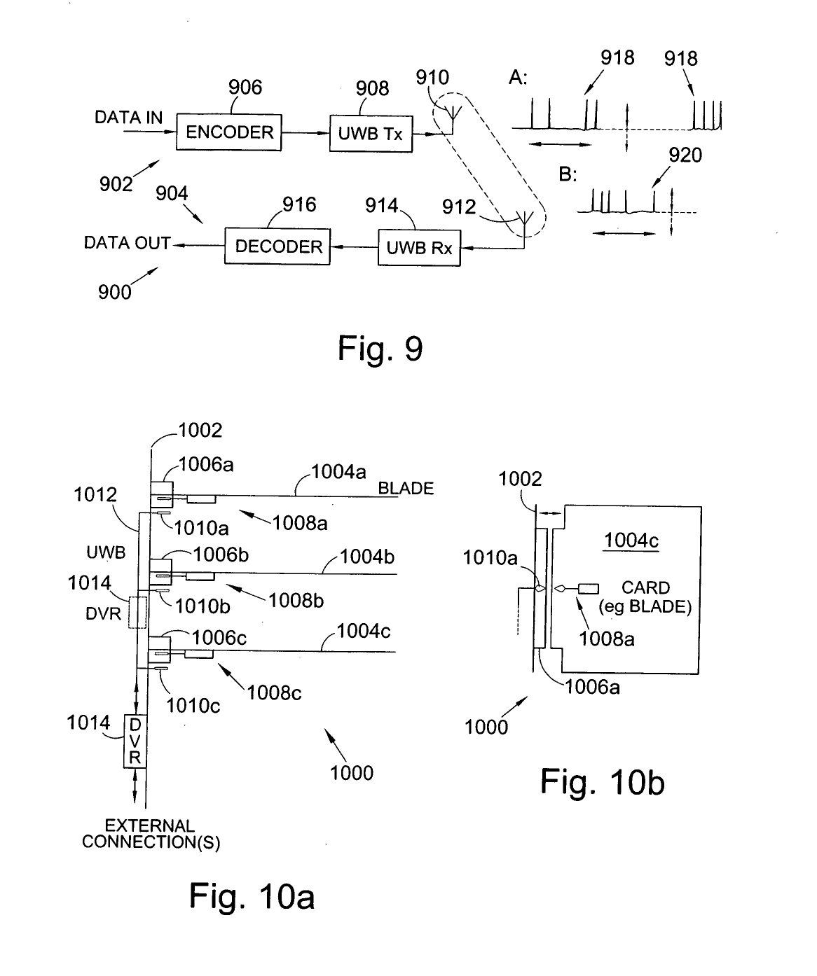

FIGS. 10a and 10b show top and side views of a UWB backplane connector system 1000 comprising a UWB backplane 1002 mounting a plurality of cards 1004a, b, c such as Blade Server cards. Each card is fitted into a connector 1006a, b, c, which mechanically holds the card but which does not need to provide any direct electrical connections to the card apart from optionally, power connections. Each card is provided with one portion of a, preferably bi-directional, UWB connector 1008a-c of the type described above. The UWB backplane is provided with at least one UWB coupling element 1010a-c for each card positioned such that when the card is inserted into its mechanical mounting the backplane coupling element is adjacent to the card coupling element. The backplane UWB coupling elements 1010 may be linked by a passive waveguide, for example a simple wire or one or more active (bi-directional) drivers 1014 may be included, in particular for coupling to external devices or connectors. Use of UWB coupling rather than, for example, optical coupling achieves high data rates without the need for very precise alignment of the coupling elements.

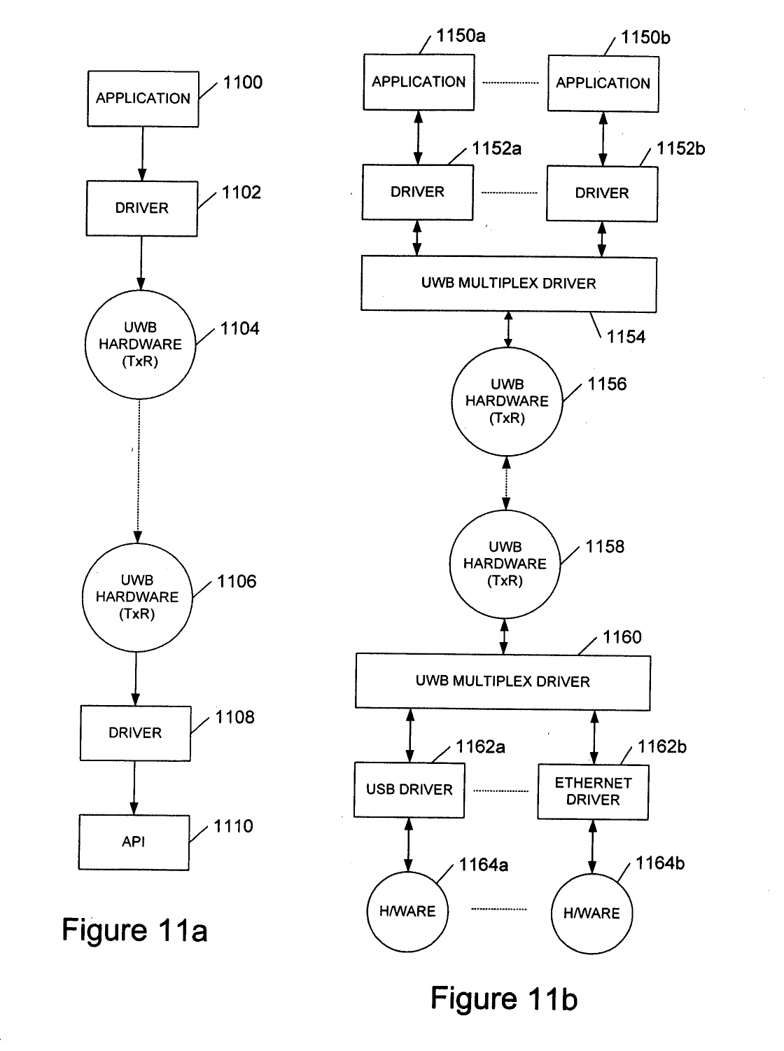

Referring next to FIG. 11a, this shows a first example driver architecture for a UWB data connector system. Application software 1100 provides data to a driver 1102 which drives UWB transmitter or transceiver hardware 1104. These components constitute a first portion of the data connector system. A second portion of the system comprises further UWB receiver or transceiver hardware 1106 providing an output to a driver 1108 which outputs data to an application program interface 1110. The skilled person will recognize that in one or more embodiments the system of FIG. 11a may provide bi-directional data communications/connection.

FIG. 11b shows a second example of a UWB data connector system architecture, which provides software interfaces for a plurality of software applications 1150a, b. These communicate with the respective virtual drivers 1152a, b which, to the applications 1150a, b, look like hardware drivers. Drivers 1152a, b each communicate with a UWB multiplex driver 1154, which in turn drives a UWB hardware transceiver 1156. The multiplex driver 1154 handles a plurality of protocols concurrently, tunneling them through the UWB hardware link. Thus UWB transceiver 1156 communicates with a second UWB transceiver 1158 in a second part of the UWB data connection system.

The UWB transceiver 1158 communicates with a second UWB multiplex driver 1160 which has a plurality of interfaces to hardware drivers 1162a, b, typically implementing standard hardware interfaces, in the illustrated example AUSB driver and an Ethernet driver. These drivers in turn provide respective hardware interfaces 1164a, b. Typical interfaces include PCI, USB, video, Firewire, Ethernet, PCMCIA and the like. The hardware interfaces are not limited to external interfaces and could, for example, comprise interfaces on a PCI chassis, for example to provide a bus-2-bus or bus-2-multibus bridge.

The driver architecture of FIG. 11b provides a substantially transparent link between applications 1150a, b and hardware interfaces 1164a, b. In one example, the UWB hardware link is adaptive, providing an adjustable data rate depending upon the use of the connector system, for example in a range 1-10 Gigabits/second, although higher data rates may readily be provided. This UWB-based solution provides low power and system cost, in particular because each of the two parts of the UWB data connector system may be implemented using a single chip which is mechanically cheap and simple. In one example, the UWB connector system provides an automatic link, which is one part of the connector system will automatically link to a second part of the connector system, when the second part is within range. In one example, the system also enables point-to-multipoint links.

Thus, the driver system can include a system for detecting when another UWB transceiver is within range, for example based upon signal strength or a “ping”-based technique, thus a UWB multiplex driver can include software to advertise its services to a second connector portion, so that, for example, available hardware interfaces can be advertised to applications and/or requested interfaces may be advertised to hardware drivers. In one or more embodiments, UWB multiplex driver 1154 creates or makes visible the relevant driver(s) 1152a, b.

The above described arrangement. can enable devices with a UWB data connection system to automatically detect and link to one another, providing appropriate services. As previously mentioned, the hardware interfaces could be internal interfaces, for example of a printer, camera, video or audio player/recorder and the like. Thus, broadly speaking, embodiments of the data connection system provide an automatic link between two or more electronic devices able to automatically detect another device and implement one or more appropriate communication protocols. In embodiments the driver software may either be provided in firmware or, for example, as software on a laptop or other computer.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A data connector system, the system comprising:
a first connector portion, the first connector portion comprising a UWB transmitter with a data input and a first UWB coupling element driven by the UWB transmitter;
a second connector portion, the second connector portion comprising a second UWB coupling element and a UWB receiver with a data output, the UWB receiver having an input from the second UWB coupling element, and
wherein the data connector system has a connected configuration in which the first and second UWB coupling elements are within an operative range of one another, such that the coupling elements are inductively coupled to one another to permit data to be transferred from the data input to the data output, and
wherein a disconnected configuration in which the first and second connector portions are separated by greater than the operative range.

2. A data connector system as claimed in claim 1, wherein the operative range is equal to or less than a near field range of each of the coupling elements.

3. A data connector system as claimed in claim 1, wherein the operative range is less than 3 cm, less than 1 cm, or less than 0.5 cm.

4. A data connector system as claimed in claim 1, wherein in the connected configuration the first and second coupling elements are substantially aligned with one another.

5. A data connector system as claimed in claim 1, wherein at least one of the first and second connector portions has a plurality of UWB coupling elements.

6. A data connector system as claimed in claim 5, wherein the plurality of UWB coupling elements have different mutual orientations.

7. A data connector system as claimed in claim 5, wherein different ones of the plurality of UWB coupling elements are configured to provide different data connectivity.

8. A data connector system as claimed in claim 5, wherein connection to different ones of the plurality of coupling elements is configured to invoke different data processing functions.

9. A data connector system as claimed in claim 8, wherein the functions include one or more of a data storage function, a data retrieval function and a print function.

10. A data connector system as claimed in claim 1, wherein:
the first connector portion includes a data multiplexer connected between the data input and the UWB transmitter, and
the second connector portion includes a data de-multiplexer connected between the UWB receiver and the data output,
whereby the connector is configured to make a plurality of simultaneous data connections.

11. A data connector system as claimed in 10, wherein at least one of the simultaneous data connections comprises a data bus connection.

12. A data connector system as claimed in claim 10, wherein at least one of the simultaneous data connections comprises a video data connection.

13. A data connector system as claimed in claim 1, wherein:
the first connector portion further comprises a UWB receiver having a data output and an associated coupling element; and
the second connector portion further comprises a UWB transmitter having a data input and an associated coupling element,
whereby the data connection system is configured for bi-directional data transmission.

14. A data connector system as claimed in any claim 1, further comprising an inductive electrical power transfer system.

15. A data connector system as claimed in claim 1, wherein the first and second connector portions lack a direct mutual electrical connection.

16. A first connector portion as defined in claim 1.

17. A second connector portion as defined in claim 1.

18. A consumer electronic device docking station incorporating one of the first or second connector portions as defined in claim 1.

19. A portable consumer electronic device as incorporating one of the first or second connector portions as defined in claim 1.

20. A substantially environmentally sealed electronic device incorporating one of the first or second connector portions as defined in claim 1.

21. An electrical backplane having a plurality of card sockets each incorporating one of the first or second connector portions as recited in claim 16.

22. A card for the backplane of claim 21, the card having a connector incorporating one of the connector portions complementary to a connector portion with which the card interfaces when installed on the backplane.

23. A UWB data connector system, the connector system comprising:
first and second connector parts, the connector parts being configured to mechanically interface to one another, each of the connector parts including a UWB coupling element,
wherein when the first and second connector parts are interfaced one of the UWB coupling elements is in the near field of the other UWB coupling elements.

24. A UWB data connector system as claimed in claim 23, wherein the first and second connector parts lack a direct electrical connection with one another.

25. A method of providing an electrical data connection using UWB coupling elements, the method comprising:
receiving data for transmission across the connection;
encoding the data as a UWB signal;
transmitting the UWB signal from a first of the coupling elements;
receiving the UWB signal at a second of the UWB coupling elements;
recovering the data from the received UWB signal; and
inductively coupling the first and second UWB coupling elements.

26. A method as claimed in claim 25, wherein the encoding comprises encoding the data as an impulsive UWB signal.

27. A method as claimed in claim 26 wherein, the encoding comprises encoding the data using one or more patterns of UWB impulses.

28. A method as claimed in claim 25, wherein the coupling comprises near-field coupling between UWB antennas.

29. A method as claimed in claim 25, wherein the coupling elements comprise monopole coupling elements.

30. An electrical data connector, comprising:
UWB coupling elements;
means for receiving data for transmission across the connection;
means for encoding the data as a UWB signal;
means for transmitting the UWB signal from a first of the coupling elements;
means for receiving the UWB signal at a second of the UWB coupling elements; and
means for recovering the data from the received UWB signal; and
wherein the connector is further configured for inductive coupling of the first and second UWB coupling elements.

31. A docking station for an electronic device, the electronic device comprising:
a plurality of separate data connections coupled to a near-field UWB interface,
wherein the docking station comprises a near-field USB interface coupled to one or both of a multiplexer and de-multiplexer, whereby the docking station is enabled to connect via an inductive wireless UWB connection to the separate data connections of the electronic device.

32. A docking station as claimed in claim 31, further comprising:
an inductive electrical power supply system for the electronic device.

33. A docking station as claimed in claim 31, wherein:
the electronic device comprises a portable computer; and
wherein the separate data connections include a video data connection,
whereby the computer is operable to receive power and display video using the docking station without making direct electrical connections to the docking station.

34. An environmentally sealed electronic device, comprising:
one or more external data connections all coupled to a near-field UWB interface,
whereby the device is operable using the one or more external data connections without making direct electrical connection to the device.

35. An environmentally sealed electronic device as claimed in claim 34, further comprising:
means to receive electrical power for powering the device inductively from an external power supply unit.

36. A method of operating an electronic device in a hostile environment, the method comprising:
providing data communications for the device using a near-field UWB coupling;
providing an electrical power supply for the device using an inductive coupling; and
operating the device using the electrical power supply to communicate data over the near-field UWB coupling.

37. A method of providing short-range UWB data communications, the method comprising:
inputting data to be communicated;
encoding the data as pattern of UWB impulses;
transmitting the pattern of impulses from a UWB transmitter to a UWB receiver;
receiving the pattern of impulses at the receiver;
decoding the pattern of impulses to provide decoded data; and
outputting the decoded data.

38. A method as claimed in claim 37, wherein the transmitting comprises transmitting at a sufficiently low power level that multipath components of the transmitted impulses at the receiver are substantially suppressed.

39. A short-range UWB data communications transmitter, comprising:
means for inputting data to be communicated;
means for encoding the data as a pattern of UWB impulses; and
means for transmitting the pattern of impulses from a UWB transmitter to a UWB receiver.

40. A UWB data communications receiver, comprising:
a received signal input to receive a pattern of UWB impulses;
means for decoding the pattern of impulses to provide decoded data; and
means for outputting the decoded data.

41. A method of selecting an operational function to be implemented by an interface unit for an electronic device, the electronic device having a short-range UWB communications interface, the interface unit having a plurality of complementary short-range UWB communications interfaces spaced apart over a region of the unit, each the interface being associated with one of the operational functions, the method comprising:
selecting a the operational function by bringing the UWB communications interface of the electronic device into range of a selected one of the UWB communications interfaces of the interface unit.

42. A method as claimed in claim 41, wherein the UWB communications interface range is sufficiently short to enable selective communications with one of the interface unit communications interfaces.

43. A method as claimed in claim 41, wherein the selecting also comprises selecting a relative orientation of the electronic device communications interface and the selected interface unit communications interface.

44. An interface unit for implementing a selected one of a plurality of operational functions for an electronic device having a short-range UWB communications interface, the interface unit comprising:
a plurality of complementary short-range UWB communications interfaces spaced apart over a region of the unit, each the interface being associated with one of the operational functions; and
means for selecting a the operational function for implementing in response to the electronic device being brought into communications range of a corresponding the communications interface.

45. An electrical backplane system, the system comprising:
a backplane;
a plurality of mechanical connectors mounted on the backplane, each configured to receive an electronic circuit;
a plurality of UWB coupling devices, at least one associated with each the mechanical connector; and
one or more wired communications links between two or more of the UWB coupling devices.

46. An electrical backplane system as claimed in claim 45, wherein the UWB coupling devices comprise inductive or near-field UWB coupling devices.

47. An electrical backplane system as claimed in claim 45, wherein the wired links include at least one active link.

48. A UWB data connector system, the system comprising:
a first UWB transceiver;
a second UWB transceiver;
a first set of software drivers for the first UWB transceiver; and
a second set of software drivers for the second UWB transceiver,
wherein the first set of drivers comprises a first UWB multiplex driver for providing a plurality of first interfaces to the first UWB transceiver, and a plurality of second drivers coupled to the plurality of first interfaces to provide a plurality of software interfaces, and
wherein the second set of drivers comprises a second UWB multiplex driver for providing a plurality of second interfaces to the second UWB transceiver, and a plurality of third drivers coupled to the plurality of second interfaces to provide a plurality of hardware interfaces.

49. A UWB data connector system as claimed in claim 48, wherein the software interfaces comprise application program interfaces.

50. A UWB data connector system as claimed in claim 48, wherein the hardware interfaces include one or more interfaces selected from the group consisting of RS-232, RS-423, RS-485, IEEE-488, IEEE-1394, USB, USB 2, personal computer parallel port, video, composite video, S-video, RGB video, PCI bus, PCI express bus, PCMCIA interface, Ethernet and digital camera interface.

51. A UWB data connector system as claimed in claim 50, wherein the software interfaces are configured to provide one or more standard interfaces for the hardware interfaces.

52. A UWB data connector system as claimed in claim 48, wherein the system is configured to provide protocol translation between a first protocol used at one or more of the software interfaces and a second protocol used at one or more the hardware interfaces.

53. A UWB data connector system as claimed in claim 48, wherein the first and second UWB multiplex drivers are configured to communicate data between the first and third drivers using a plurality of protocols concurrently.

54. A UWB data connector system as claimed in claim 48, wherein one or both of the first and second UWB multiplex drivers include a service discovery protocol for discovering one or more services provided or requested by another the UWB transceiver and driver set.

55. A UWB data connector as claimed in claim 54, wherein the service discovery protocol includes one or more of: a protocol to detect whether another the UWB transceiver is within range, a protocol to advertise one or more services which may be offered to the another the UWB transceiver and driver set, and a protocol to make available one or more of the first, second or third, drivers to the other the UWB transceiver and driver set, responsive to a the service advertisement.

56. A UWB data connector in claim 48, comprising:
a third UWB transceiver; and
a third set of drivers for the third UWB transceiver, the third set of drivers comprising:
a third UWB multiplex driver for providing a plurality of third interfaces to the third UWB transceiver, and
a plurality of hardware or software interface drivers coupled to the plurality of third interfaces,
whereby the UWB data connector system is enabled for point-to-multipoint data connection.

57. A UWB data connector system, the system comprising:
a first UWB transceiver;
a second UWB transceiver;
at least one driver for the first UWB transceiver; and
at least one driver the second UWB transceiver,
wherein one or both of the drivers include a service discovery protocol for discovering one or more services provided or requested by the other the UWB transceiver and driver.
